(19) United States
(12) Patent Application Publication
(10) Pub. No.: US 2013/0103739 A1
(43) Pub. Date: Apr. 25, 2013

(54) Obtaining Dynamic Connected-Network Topology Via any Node in Network

(71) Applicants: Gonzalo A. Salgueiro, Holly Springs, NC (US); Joseph M. Clarke, Cary, NC (US); Carlos M. Pignataro, Raleigh, NC (US)

(72) Inventors: Gonzalo A. Salgueiro, Holly Springs, NC (US); Joseph M. Clarke, Cary, NC (US); Carlos M. Pignataro, Raleigh, NC (US)

(73) Assignee: CISCO TECHNOLOGY, INC., San Jose, CA (US)

(21) Appl. No.: 13/278,630

(22) Filed: Oct. 21, 2011

(51) Int. Cl. G06F 15/16

(52) U.S. Cl. 709/203

(57) ABSTRACT

A method, an apparatus and computer readable storage media facilitate obtaining of a current network topology within a network by requesting this topology from any node within the network, where the topology can be provided in any manner that is suitable to the requester. In an example embodiment, a connection is established between a computing device and a network including a plurality of nodes, each node connected with at least one other neighboring node within the network, each node further including a network element configured to receive and transmit data to and from other nodes. A request is sent for current network topology information from the computing device to any selected node within the network, where the selected node has current network topology information. A graphical image of the current network topology is provided at the computing device that is based upon the current network topology information.

### TECHNICAL FIELD

The present disclosure relates to discovery systems for obtaining the topology of an existing computer network, including connections between nodes and information about nodes within an existing network.

### BACKGROUND

During the troubleshooting and/or debugging of computer network issues, technical support engineers and other support personnel need mechanisms to rapidly and reliably understand the network. Obtaining a current, up-to-date topology of a computer network that is accurate, including information regarding particular nodes of the network, can be a difficult and challenging task. In particular, a technical support engineer or operator for the network needs to gather information to obtain a “snapshot” of the network topology in order to resolve potential problems with the network (e.g., capacity and/or routing issues within the network).

Obtaining incremental knowledge of a network topology requires a significant investment on the part of engineer or operator performing troubleshooting, design, or other consultation services. The topology map of a network is the foundational tool to effectively understand a network and it is a universal construct that is both graphical and dynamic in nature, requiring periodic updates to accurately assess the network.

The technical support engineer can attempt to obtain a network topology in certain ways. For example, the engineer can ask customers or clients to provide their version (as best understood by the clients) of the topology. However, such versions can be grossly outdated and inaccurate or seriously lacking in details associated with nodes of the network. In another example, the engineer can attempt to manually draw or map the network topology, e.g., based upon having offline information about nodes stored in a database accessible to the engineer. However, this method can also be prone to errors and is further a difficult and time consuming task.

### BRIEF DESCRIPTION OF THE DRAWINGS

FIG. 1 is a schematic diagram depicting the topology of a computer network comprising a plurality of nodes connected to each other across communication lines, including a network monitoring device at one node that obtains information from the other nodes to determine the network topology.

FIG. 2 is a schematic block diagram of an example network node configured to communicate with other network nodes in the system of FIG. 1.

FIG. 3 is a flow chart that depicts an example process for operating the network monitoring device within the network of FIG. 1 to obtain a current topology and/or additional information for the network.

FIG. 4 is a schematic diagram depicting the topology of the computer network of FIG. 1, including an overlay that provides additional information in relation to the nodes of the network.

FIG. 5 is a schematic diagram depicting the topology of the computer network of FIG. 1, including an overlay that provides additional information relating to a flow path of data packets through the network to a database.

FIGS. 6-8 are schematic diagrams depicting the topology of the computer network of FIG. 1 at different times in which changes to the network have occurred.

### DESCRIPTION OF EXAMPLE EMBODIMENTS

### Overview

A method, an apparatus and computer readable storage media facilitating the establishment of a connection between a computing device and a network comprising a plurality of nodes, each node connected with at least one other node within the network, each node further comprising a network element configured to receive and transmit data to and from other nodes. A request is sent from the computing device to any selected node within the network, where the selected node has current network topology information or has access to current network topology information that is located at another node. Information is received at the computing device about the current network topology from the selected node, and a graphical image of the current network topology is provided at the computing device that is based upon the current network topology information.

### Example Embodiments

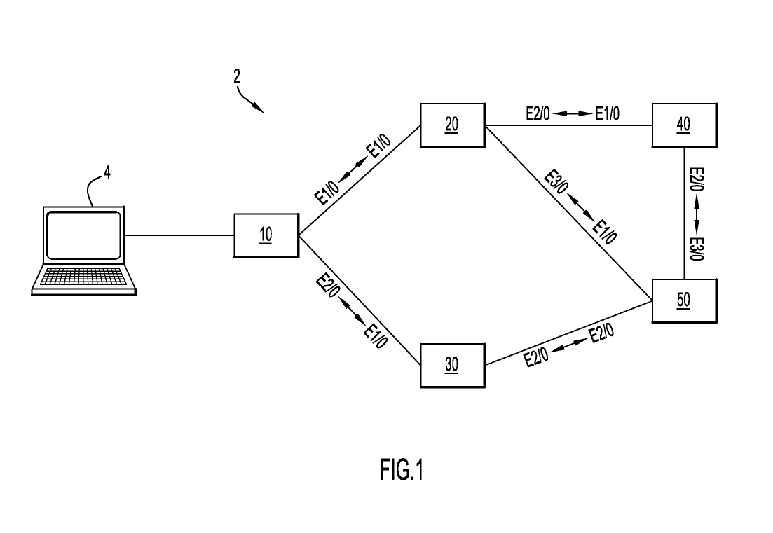

Referring to FIG. 1, a schematic diagram depicts the topology of a computer network 2 comprising a plurality of nodes 10, 20, 30, 40, 50 connected with each other via communication lines. It is to be understood that a network topology, as used herein, refers to a layout or pattern of network elements or nodes that are interconnected via communication links.

The computer network 2 can be any suitable network that facilitates transmission of information (e.g., information in the form of data packets) to two or more nodes of the network. Examples of types of networks that can be utilized include, without limitation, local or wide area networks, Internet Protocol (IP) networks such as intranet or internet networks, telephone networks (e.g., public switched telephone networks), wireless or mobile phone or cellular networks, and any suitable combinations thereof. The nodes can be separated from each other by any suitable distance, where communication lines connect each node with at least one other node within the network to facilitate transfer of information (e.g., in the form of data packets) between network nodes. The communication lines can be any suitable connection (e.g., hardwired and/or wireless connections) that facilitate a communication path for transfer of information or data between nodes over the network 2. It is noted that, while only five nodes are shown in FIG. 1, this is simply for illustrative purposes and it is understood that the network 2 can include any suitable number of nodes.

In an example embodiment, each node within the network 2 includes a network element that receives data packets from one or more other nodes and forwards or transmits data packets to one or more other nodes to which the node is connected via corresponding communication lines connecting the nodes. Each node can include any suitable type or types of network elements capable of communicating and receiving and sending data packets between the node and one or more other nodes of the network. Some examples of suitable network elements include, without limitation, routers, switches, servers, IP phones and/or other types of devices configured to communication and exchange data with other devices. The network elements can include any suitable number of data ports to receive data packets from and transmit data packets to other nodes within the network 2 and to further communicate with network elements at other nodes and also network monitoring devices located at one or more nodes within the network 2. The network elements can use any suitable networking protocol for communication (e.g., an Ethernet protocol) for facilitating communication, receipt and transfer of data packets between network nodes.

Each node can further include one or more other computing devices, including any selected number and types of peripherals connected or coupled in any suitable manner to each computing device (e.g., keyboards, display monitors, printers, scanners, external data storage devices, modem devices, routers, etc.). Each computing device includes a processor to control functions of the computing device as well as peripherals associated with the computing device. Examples of computing devices include, without limitation, computer servers, stationary (e.g., desktop) personal computers and personal mobile computer devices such as laptops, note pads, tablets, personal data assistant (PDA) devices, and other portable computing devices. In addition, any one or more nodes of the network can further comprise any number of sub-nodes of computing devices interconnected with each other (e.g., via a local server over a local network that is a sub-network of the main network 2).

An example embodiment of a network monitoring device 4 is generally depicted in FIG. 1 for use by a system engineer or operator to communicate with other nodes over the network (e.g., the network monitoring device can be a technical assistance center for the network). The network monitoring device 4 can be of any suitable type, including the previously described types of computing devices. While the network monitoring device 4 is connected with node 10 as shown in FIG. 1, this is for illustrative purposes only and it is noted that the network 2 can include one or more network monitoring devices located at any one or more nodes disposed within the network.

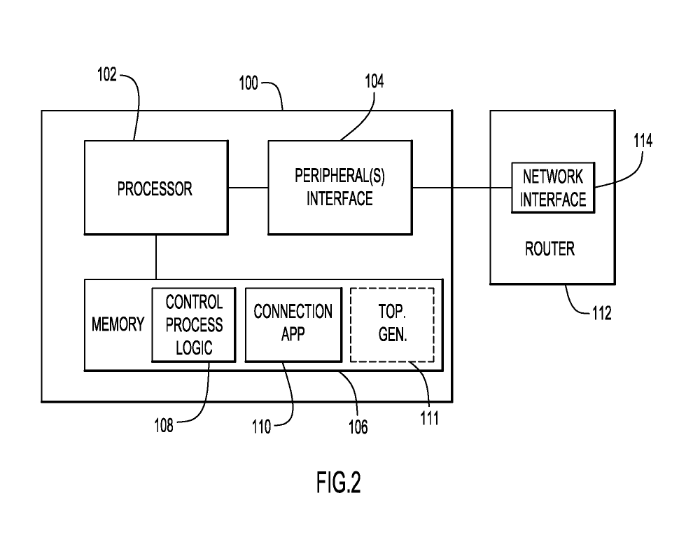

An example embodiment of a node is schematically depicted in the block diagram of FIG. 2. It is noted that the node can be any of the nodes 10, 20, 30, 40, 50 as depicted in FIG. 1. The node includes a computing device 100, where the computing device 100 includes a processor 102, a peripheral interface 104, and a memory 106. The processor 102 is a microprocessor that executes control process logic instructions 108 (e.g., operational instructions and/or one or more software applications stored in memory 106).

The peripheral interface 104 includes any selected number of interface connection ports (e.g., USB, Ethernet and/or other types of serial connection ports) that facilitate communications with any selected number of peripheral devices connected to the device 4. The processor 102 further connects (e.g., via a peripheral interface connection port) to a network element, depicted in FIG. 1 as a router 112. However, as previously noted, the network element can also be configured as other types of devices that facilitate exchange of communications and data (e.g., in the form of data packets) between the node depicted in FIG. 2 and other nodes of the network. While the computing device 100 and the router 112 are shown as separate components in FIG. 2, it is noted that these two components can also be integrated within a single computing device. In addition, the router 112 can include its own processor (e.g., in an embodiment in which the router is a separate component from a computing device such as device 4) to facilitate communication with network elements and/or other computing devices at other nodes.

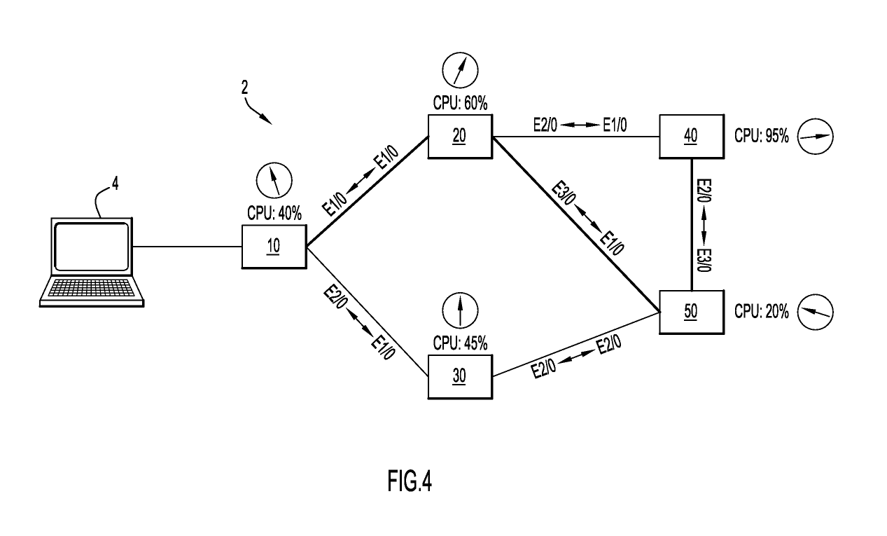

The router 112 includes a network interface 114 that includes any selected number of data connection ports (e.g., Ethernet ports) that facilitate a connection of node 10 with any selected number of other nodes (e.g., a connection between node 10 and nodes 20 and 30 as shown in FIG. 1), which facilitates a transfer of data (e.g., in data packets) between the connected nodes along their communication lines (e.g., the lines shown in FIG. 1 that connect each node to one or more other nodes). For example, as shown in FIG. 1, the router 112 of node 10 connects via its connection (e.g., Ethernet) port E1 to the connection port E1 of a network element for node 20, while node 10 also connects via its connection port E2 with the connection port E1 of a network element for node 30. The specific connection ports (E1, E2, E3, etc.) that are utilized by the network elements of each node for connecting with network elements of other nodes are also shown along the communication lines depicted in FIG. 1 (and also FIGS. 4-9).

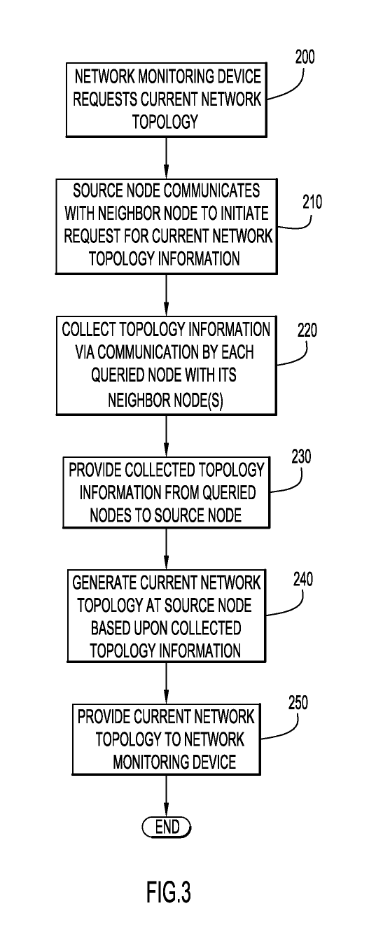

The memory 106 of the device 4 can include random access memory (RAM) or a combination of RAM and read only memory (ROM), magnetic disk storage media devices, optical storage media devices, flash memory devices, electrical, optical, or other physical/tangible memory storage devices. The processor 106 executes the control process logic instructions 108 stored in memory 106 for controlling the device 4, including the performance of operations as set forth in the flowchart of FIG. 3. In general, the memory 106 may comprise one or more computer readable storage media (e.g., a memory device) encoded with software comprising computer executable instructions and when the software is executed (by the processor 102) it is operable to perform the operations described herein in connection with control process logic instructions 108. The memory 106 further stores data associated with information obtained by nodes of the network that determine network topology in the manner described herein.

In addition, memory 108 includes a connection application module 110 that utilizes any one or more software applications utilizing one or more suitable discovery algorithms capable of determining operational conditions over the network at any given time, including relationships between two or more nodes in a network, as well as information corresponding with one or more particular nodes in a network (e.g., what computing devices, peripherals, etc. may be located at a particular node, what the bandwidth capacity is for a particular node, the computing or CPU capacity for a particular node, etc.). Some non-limiting examples of algorithms for determining such information include algorithms utilizing an Interior Gateway Protocol (IGP), algorithms using a Link Layer Discovery Protocol (LLDP), and algorithms utilizing a Cisco® Discovery Protocol (CDP) (a discovery protocol developed by Cisco Technology, Inc. to automatically learn about devices connected at nodes within a network). The connection application module 110 can also include additional software applications capable of providing other information about the network, such as applications that provide information regarding the pathway of data packets that are transmitted from a source node to a destination node or location within the network 2, with specific information that can be collected on a hop-by-hop basis between nodes (e.g., to obtain information relating to flow statistics and utilization information for incoming and outgoing interfaces, CPUs, and memory, as well as any changes to IP routes). Example applications that are suitable for providing such information include Cisco Systems' Mediatrace™ and applications utilizing multicast.

As previously noted, each node in the network 2 can have a similar configuration as the node depicted in FIG. 2, including a router (or other network element) and/or one or more computing devices having the same or similar configurations as the computing device 100 and router 112. For example, the network monitoring device 4 for node 10 can have the same or similar configuration as the computing device 100. Each node can further include a memory including a connection application module similar to the previously described module 110 for communicating with other nodes and obtaining information relating to the nodes and to operational conditions of the network. The computing devices and/or routers or other network elements of each node can utilize any suitable operating systems (e.g., Cisco IOS, Windows, Mac OS, Symbian OS, RIM Blackberry OS, Linux, Android, etc.) to facilitate operation, communications and other interactions between the routers and/or computing devices with other routers and/or computing devices over the network 2.

In accordance with example embodiments, information about the current network topology can be obtained by making a request at any node within the network, where the current network topology information can be provided in a format or manner that is best suitable to the requester. The example embodiments facilitate obtaining information of current network topology over an entire network domain or, alternatively, over only portions of a network domain (e.g., specific nodes or locations within the network that may be of interest to a requester).

Obtaining current network topology from any node within a network can be achieved in a number of ways. For example, the system can be configured such that every node within the network has information about the current network topology such that, at any given time, any node can be queried (e.g., by a network monitoring device or any other computing device) to obtain the current network topology. Alternatively, in another example, only a select number of nodes (e.g., one, two or more) within the network may have information about the current network topology, where such nodes can share this information with other nodes such that every node within the network is capable of providing current network topology information based upon a request for such information.

In an example embodiment, a network management system (NMS) server could access the network via one or more specified nodes in order to obtain information from other nodes. The nodes can exchange link-state advertisement (LSA) data with each other utilizing a link state routing protocol, such as OSPF (Open Shortest Path First). The NMS server collects the exchanged LSA information at any selected time periods (e.g., on a periodic basis) from different nodes within the network utilizing any suitable protocol (e.g., SNMP, XML-RPC, REST, etc.). Simple Network Management Protocol (SNMP), where the collected LSA information can be used to generate current network topology for a specified network domain. The NMS server periodically shares current network topology information with selected nodes of the network (e.g., via multicast messaging of the information to the nodes). Thus, at any given time, a requester can request current network topology information from any node within the network, and such node can provide the requested information immediately to the requester.

In another example embodiment, a single node within the network can be designated as a seed or source node which is responsible for initiating network topology requests, where nodes are instructed to collect and provide the requested information to the source node so that the source node can construct or generate a mapping of the current network topology based upon the collected information obtained from the other nodes. The source node can further provide information to a network engineer stationed at a network monitoring device (e.g., network monitoring device 4 at node 10 for network 2 as shown in FIG. 1) at any time the network engineer requests such information.

The network engineer can make a request for the current network topology, either directly from the source node or, alternatively, from any other node in the network. For example, the source node might be designated as the sole possessor of any existing or known network topology information (having been previously acquired by a query of the nodes), or the source node can share such information with one or more other nodes within the network (thus allowing the network engineer to obtain the information from any selected node within the network). In addition, each node can be configured so as to be a designated source node (e.g., any network node selected by a requester to obtain current network topology information can serve as a source node), since the same type(s) of information will be obtained and provided to the designated source node for generating the current network topology. Further, a plurality of sources nodes can also be designated within a particular network. Thus, this protocol does not require a dedicated discovery station (e.g., an NMS server or other single source) to collect and provide current topology information about the network.

The protocol of the network topology request obtained from a source node provides a “breadcrumb” approach in which a queried node can respond back to the requesting node (i.e., the originating or source node, or any other intermediate requesting node located one or more hops from the source node) directly or, if no communication path exists to the requesting node, the queried node can reply to any other upstream neighboring node, which in turn replies to the requesting node, or again to its upstream neighboring node. This process continues recursively until the requesting node is reached. Ultimately, all requested topology information, which was initiated by the source node, is routed to the source node, and the source node utilizes the collected network topology information to generate a current network topology.

A domain on the network topology can also be set, e.g., to limit the information obtained from the query to a specified number of nodes or a limited range (e.g., a limited number of hops) in relation to the source node. Current topology information can be provided based upon constraints or limits established by the requester. For example, the requester may be interested in a particular node or set of nodes within the network instead of an entire network domain. The request for current network topology information can be limited, e.g., based upon hop counts from one or more specified network nodes, or based upon other factors such as an area within the network that may be experiencing performance issues (e.g., identifying one or more nodes having bandwidth issues and providing current network topology information for such nodes, including nodes within a specified range or hop count from such identified nodes). In a scenario in which the current network topology information is generated in response to a request, the limiting of the network topology generation to a specified area (e.g., an area of the network in which a network engineer is troubleshooting) facilitates a more rapid response as opposed to having to obtain current network topology for a greater or more expanded network domain.

The source node can also initiate collection of a number of different types of information from any node in the network, including additional layered information relating to current operational conditions of the network (e.g., performance information, health of network elements, computing devices, etc. at any node, requests for nodes to enable dynamic tracing or monitoring of data packets being routed through the network, etc.).

Each node utilizes software (such as software described above for the connection application module 110) to communicate with neighboring nodes (i.e., nodes that are directly connected with a node) in order to obtain the requested topology information for use by the source node to generate the network topology. The source node further includes a topology generation module 111 that is configured to utilize the collected topology information to generate the current network topology based upon such information. It is noted that some or all of the nodes may include the topology generation module 111 so as to serve as a designated source node. The information obtained by nodes querying their neighboring nodes (i.e., nodes to which a querying node is directly connected) provides sufficient information (e.g., information including a link-state advertisement (LSA) table, a routing table, etc.) for each node that facilitates mapping of the nodes (e.g., utilizing the topology generation module 111) so as to obtain an accurate indication of the current network topology.

The network monitoring device 4 communicates with any selected node (e.g., any of nodes, 10, 20, 30, 40) of the network 2 to obtain a current topology of the network at any given time that is desired by a network operator or engineer. In particular, a request can be sent by the network monitoring device 4 to any selected node of the network to provide the current network topology (or any selected portion or domain of such current network topology) to the device 4. In scenarios in which the network monitoring device 4 queries a distant node (i.e., a node that is not directly linked via a communication line with node 10, such as nodes 40 and 50 as shown in FIG. 1) for obtaining the current network topology, the query can be transmitted in one or more data packets along the nodes of the network to the node that is being queried. For example, a current network topology query can be directed from the network monitoring device 4 at node 10 to selected node 50 via node 20 (and, optionally, also via node 40) or via node 30. As previously noted, the selected node from which the network monitoring device 4 requests network topology information could be the source node or some other node. In a scenario in which the selected node is the source node, the source node provides the current network topology to the network monitoring device 4. In a scenario in which the selected node is not the source node, the system can be configured such that the source node provides the current network topology to the selected node, which then provides the current network topology to the network monitoring device 4.

Thus, while no single node in the network may have the current network topology prior to a current network topology request being initiated by the source node, the current network topology can be obtained at any point in time by a source node and the network monitoring device can request a current network topology from any node in the network.

Operation of the system to obtain current network topologies via a source node within the network 2 is now described with reference to the flowchart of FIG. 3. At 200, a network monitoring device, such as device 4 at node 10, requests a current network topology from any selected node of the network (e.g., any of nodes 20, 30, 40, 50) to obtain a current version of the network topology. The communication between the network monitoring device 4 and the selected node can be achieved utilizing any suitable method, including utilizing a command line interface (CLI) between network monitoring device 4 and the nodes, utilizing a web browsing interface (e.g., a hypertext transfer protocol (HTTP) interface that provides a visual indication of the topology as best known at the time the request is being made and that further allows the network monitoring device 4 to point to a node in the interface to establish a communication with the selected node), or utilizing any other suitable communication mechanism over the network 2 (e.g., utilizing Smart Call Home message system commercially available from Cisco Technology, Inc.). In an example embodiment, the network monitoring device 4 sends a CLI command to a selected node in the network 2 (e.g., accessing the selected node by its node address or designated name for the node, where the CLI command is directed to the selected node via its address in the network) requesting the current network topology. The request ultimately results in the source node providing the current network topology to the network, either directly (i.e., where the source node is also the selected node to which the network monitoring device 4 has made the request) or indirectly (i.e., by the source node providing the current network topology to the selected node, and the selected node forwarding the current network topology to the device 4).

At 210, the source node communicates with at least one of its neighboring nodes (i.e., nodes which are directly connected to the source node via communication lines) to initiate the request for current network topology information. Upon such initiation of the request by the source node, at 220, topology information is collected by the neighboring node that was queried by the source node in turn querying its neighboring nodes (i.e., nodes that are directly connected with this node via communication lines), and its neighboring nodes querying their neighboring nodes, and so on so as to obtain a collection of topology information from nodes in an outward expanding, spider-like manner along the communication line connections from the source node.

For example, in a scenario in which a source node for network 2 is node 40, node 40 initiates the request by communicating with node 20 (node 40 is connected via connection port E1 of its network element with connection port E2 of the network element for node 20) and/or node 50 (node 40 is connected via connection port E2 of its network element to connection port E3 of the network element for node 50). As the network topology request expands outward to the next hop in the network 2 from node 40, node 20 obtains information from node 50 (node 20 is connected via connection port E3 of its network element to connection port E1 of the network element for node 50) and node 10 (node 20 is connected via connection port E1 of its network element to connection port E1 of the router 112 for node 10), while node 50 obtains information from node 20 (node 50 is connected via connection port E1 of its network element to connection port E3 of the network element for node 20) and node 30 (node 50 is connected via connection port E2 of its network element to connection port E2 of the network element for node 30). A further outwardly expanding hop within the network results in node 30 obtaining information from node 10 (node 30 is connected via connection port E1 of its network element to connection port E2 of the router 112 for node 10).

At 230, all of the collected topology information obtained by nodes in the network 2 is directed back through the network to the source node 40. For example, nodes 50 and 20 provide the topology information collected at these nodes back to node 40 via their direct connections with node 40, while nodes 10 and 30 provide the topology information they have collected back to node 40 via nodes 20 and 50, respectively. At 240, the source node 40 generates the current network topology based upon the collected topology information this node has received from the other nodes of the network 2.

It is noted that the process steps of 210-240 can occur independently of the network monitoring device 4 requesting a current network topology from any selected node within the network 2. For example, the source node (e.g., node 40) can periodically obtain current network topology information and generate a current network topology (via steps 210-240) based upon any changing condition within the network including, without limitation, addition of new nodes and/or new communication lines between known or existing nodes within the network 2, any changes in operational conditions of the network, etc. Thus, under such a scenario, one or more source nodes of the network 2 periodically generate a current network topology that can be provided at any given time to a requester making a request from any node within the network.

Alternatively, the source node can generate the current network topology, or any selected portion or domain of the network topology, based upon receiving a request by a network monitoring device or other requester. As previously noted, the network can be configured such that each node can function as a source node for generating current network topology (over the entire defined network domain and/or over selected portions of the network domain). In such a scenario, any selected node to which a query for current network topology is sent becomes the source node for obtaining the current network topology.

At 250, the current network topology is provided by the selected node to the network monitoring device 4 (i.e., in response to the request being made at 200). As noted above, either the source node (e.g., node 40) provides the current network topology to the network monitoring device 4 (e.g., in a scenario in which the source node is also the selected node that receives the request from the device 4) or another selected node provides the current network topology to the device 4 (where the selected node first receives the current network topology from the source node).

The current network topology that is generated by the source node can be provided to the network monitoring device in a number of different formats. In particular, the current network topology can be provided to a network monitoring device in any suitable format for use by the network engineer (e.g., where such format may be specified by the network monitoring device in its request for the current network topology). The current network topology can be generated and provided to the network monitoring device, e.g., as a graphical image (e.g., as a portable network graphics (PNG) image, a JPEG image, a GIF image, etc.) for display on a display device associated with the network monitoring device 4. In an example embodiment, the network monitoring device 4 sends a CLI command requesting the current network topology from a selected node, with the further request that the network topology be sent, e.g., as a graphical image in an email message to the engineer's email address. In this example, the selected node receives a graphical image of the generated current network topology from the source node and sends this graphical image via an email message to the email address of the operator. A graphical image of the current network topology can be provided, e.g., in a format such as is depicted in FIG. 1, which depicts the network topology in a format that is easily understood and usable by the network engineer.

In an alternative embodiment, the network monitoring device 4 can be configured to further process the current network topology information received from the source node and/or selected node and provide a graphical image based upon such information for visual display by the device 4. In other words, the network monitoring device 4 processes the current network topology information received from a node to form a graphical image that utilizes this information to display the current network topology.

The graphical image of the current network topology can also include additional information provided as an overlay on the graphically depicted topology for each node, including node address (e.g., 10.1.1.100 for node 10), connection ports for network elements (e.g., routers) associated with communication lines in the network (as shown in FIG. 1), and other types of information. As previously noted, the information provided from one node to another requesting node during the obtaining of information from the nodes can include any selected types of information about each node, including information about the type(s) of computing device(s) located at each node, peripherals connected with such computing device(s), CPU usage and capacity at each node at the time of the request, bandwidth information at each node at the time of the request, etc. Such information can be used to enrich the value the topology provides as well as the understanding of the current network functionality by providing an overlay of such information onto the graphical image of the network topology.

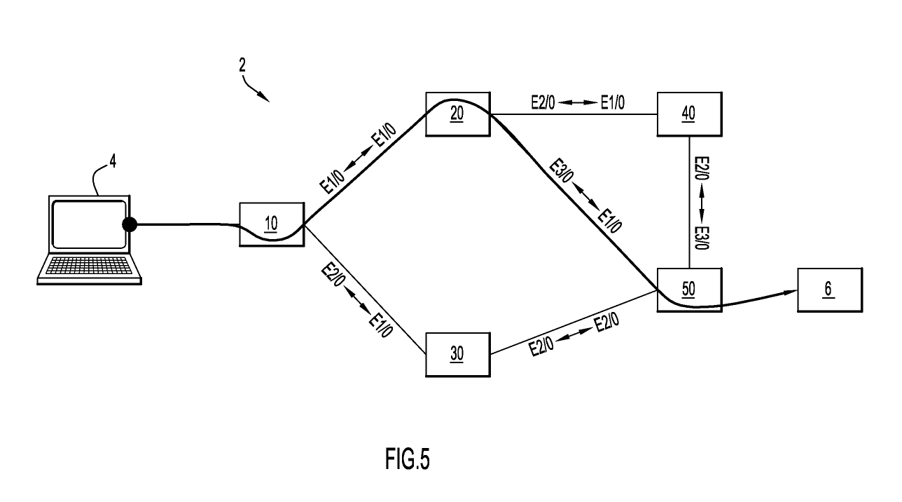

Some examples of different types of information that can be overlayed upon a graphical image of the current network topology are depicted in FIGS. 4 and 5. Referring to FIG. 4, the current CPU usage (i.e., a number representing percentage of CPU capacity and/or an arrow indicating the amount of CPU being used) for a computing device is listed at each node (e.g., node 40 is currently at 95% CPU usage). In addition, the amount of bandwidth being used during transfer of data packets at or between nodes can be presented by providing graphical images of communication lines between such nodes that are different, for example having a different color (e.g., a darker color vs. a lighter color), different line width (e.g., thicker vs. thinner lines) and/or different types of line designations (e.g., dashed line vs. solid line). As shown in FIG. 4, the communication lines depicted in the graphical image between different nodes have varying degrees of thickness, which can be used to designate differences in amount of bandwidth (e.g., data transfer rate, such as a bit rate) currently being used or that is currently available along such communication lines. In particular, the communication line between node 20 and node 40 is depicted with the least thickness (e.g., to indicate the least bandwidth usage or greatest bandwidth available between these nodes), whereas the communication lines between node 10 and node 30 and node 30 and node 50 have a slightly greater thickness (e.g., to indicate more usage of bandwidth, or less available bandwidth between these nodes), while the communication lines between node 10 and node 20 and node 20 and node 50 have the greatest thickness (e.g., to indicate greatest bandwidth usage or least bandwidth available between these nodes). This information is useful to provide an understanding to a network operator or engineer as to which pathways between nodes may encounter bandwidth issues and/or a data travel pathway that may provide the best performance during transfer of data at a given time period over the network 2.

The graphical image of the current network topology depicted in FIG. 5 shows how a dynamic tracing or monitoring of data packets that travel through the network 2. In particular, a travel or flow path of data packets is depicted over the network 2, via the solid and bolded line layered over the graphic image of the current network topology and extending along communication lines from node 10 to nodes 20 and 50. This provides information to the network operator/engineer in relation to precisely how data packets traveled from a source address (node 10) to a destination address at node 50, which includes a destination 6 (e.g., a server, a database and/or any other type of computing device). This information can be obtained during a network topology query of the nodes, where the information provided by each node includes information regarding recent data packets, or specifically identified data packets, that may have been received at each node and delivered to one or more other nodes. A network engineer can utilize this information (e.g., in combination with bandwidth information provided in the overlay of FIG. 4) to determine how data flows through the network based upon current network conditions and to solve or troubleshoot potential issues associated with data flow within the network (e.g., by identifying bandwidth, CPU and/or other issues at or between nodes).

As previously noted, a request for a current network topology can be initiated by a source node periodically with any selected frequency or based upon any changing conditions within the network, so as to obtain an up-to-date and current topology at any given time, including current information associated with the network (e.g., bandwidth issues along communication lines, CPU usage at particular nodes, etc.). Optionally, an updated network topology generated by a source node can be automatically provided to a network monitoring or other computing device at any particular time or frequency (e.g., at any selected time interval) or based upon any changing operating condition to the network (e.g., due to the introduction of any new node to the network, the addition of a new connection between two previously unconnected nodes, a change above or below a threshold value in CPU usage at a particular node, a change above or below a threshold value of a bandwidth usage or capacity between two or more nodes, etc.). For example, each intermediate node (i.e., not a source node) can be configured to provide a communication to a source node when the intermediate node detects a change in condition at the intermediate node, and this can trigger the process of obtaining current network topology information and generating a current network topology by the source node.

Each node can further retain information that is shared with the other nodes during a network topology query regarding a time period at which such node became directly connected with one or more other nodes. This information can be used (e.g., by the connection application module 110) to generate a graphical display depicting a changing view of the network topology over a selected time period.

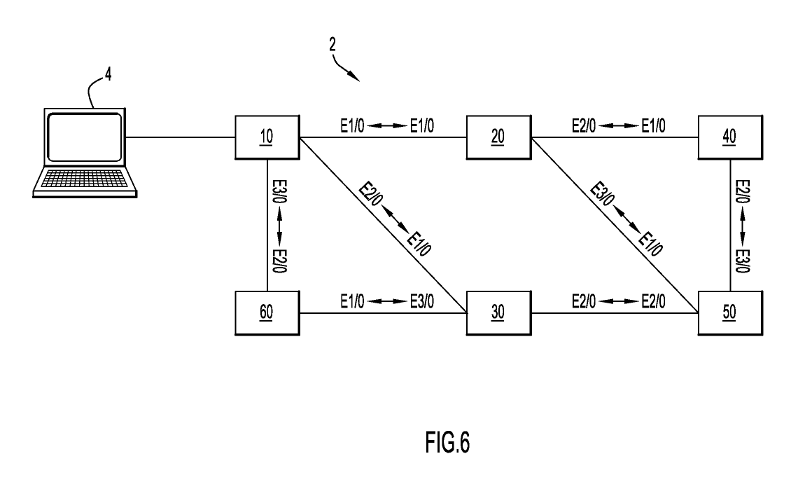

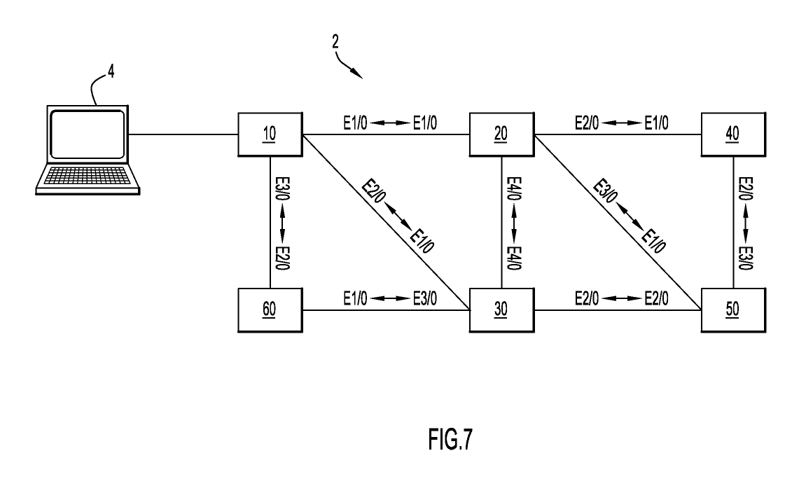

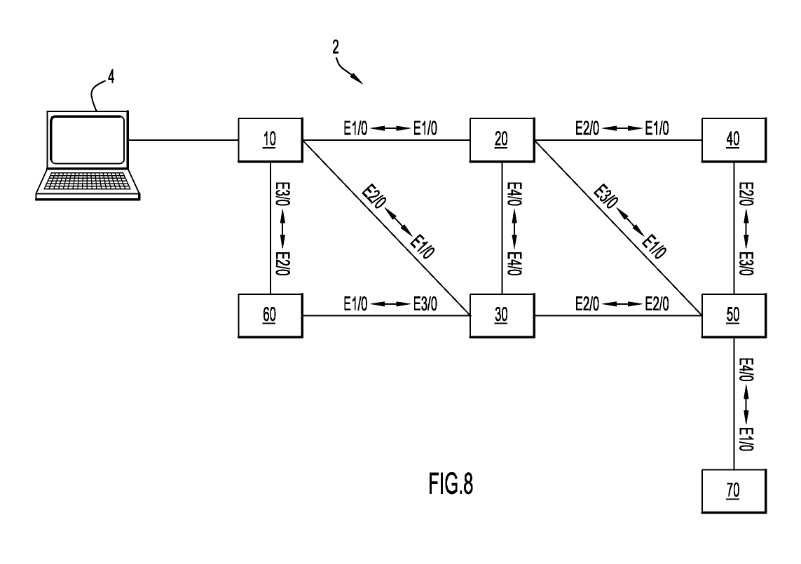

The example embodiments of FIGS. 6-8 depict a scenario in which the network 2 changes over time from the topology depicted in FIG. 1 due to additional nodes being added to the network and/or additional communication lines being created between existing nodes. In particular, the current network topology depicted in FIG. 6 is at an elapsed time period since the network topology was last obtained as depicted in FIG. 1, and FIGS. 7 and 8 show the further chronological evolution of or changes to the network topology.

As depicted in FIG. 6, an additional node 60 has been added to the network 2 that connects with node 10 (connection port E3 for the router of node 10 connects with data port E2 for the network element of node 60) and with node 30 (connection port E1 for the network element of node 60 connects with connection port E3 for the network element of node 30). In the next, sequentially updated network topology shown in FIG. 7, a further communication line has been added to connect node 20 with node 30 (connection port E4 for the network element of node 20 connects with connection port E4 for the network element of node 30). As depicted in the further sequentially updated network topology of FIG. 8, another node 70 has been added to the network 2 and is connected with node 50 (connection port E4 for the network element of node 50 is connected with the connection port E1 for the network element of node 70).

The information provided by the graphical images of FIGS. 1 and 6-8 can be presented, e.g., as a sequential visual presentation to the network engineer via a display device connected with the network monitoring device 4. In other words, a topology version control mechanism is presented that provides a historical view of the network by storing a configurable number of topology snapshots at configurable time intervals. The presentation of the historical view of the network can be in the form of a series of snapshots at set intervals, e.g., in a movie-style presentation showing the evolution of the network over a given period of time.

As previously noted, when a change to the network topology occurs (e.g., a new node or a new connection between existing nodes is added, or an operational condition at one or more nodes changes that exceeds a threshold value or a threshold range of values), the network topology can be automatically updated to indicate such change (e.g., a message can be sent to the source node indicating that a topology change has occurred and an update to the topology is needed). The obtaining of additional information that enriches an understanding of the network operation (e.g., dynamic tracing, performance monitoring at nodes, such as monitoring of CPU usage, bandwidth usage or capacity, etc.) can further be selectively enabled and disabled according to any selected time schedule (e.g., enabling a data packet trace through the network and leaving the trace enabled for a specified amount of time, where dynamic packet tracing can also be filtered using flow definitions, for example, source/destination add, port, application id (using Network Based Application Recognition), etc.).

The embodiments described herein can further be configured to facilitate initiation of a network topology query from any node so as to provide current topology information when and where it is needed (i.e., to any node) in the format best suited to the requester of the topology. Any computing device (e.g., a network monitoring device or any other suitable computing device) or requesting entity can be utilized to select any node within the network for obtaining the current network topology.

In addition, the topology can be presented in any manner that is most consumable by the requesting entity (e.g., as a graphical display viewed by a network operator/engineer at a network monitoring device, in a format for use by a network management system or other type of automated system, etc.). Some non-limiting examples of suitable formats for providing the topology information obtained by the nodes includes generating the topology in an XML format that is machine-readable, in a configuration file format for use by a network virtualization system (e.g. Cisco IOS on UNIX), or in any other suitable format (e.g. utilizing a Smart Call Home message system commercially available from Cisco Technology, Inc.). Alternatively, the requesting entity can receive current network topology information from any selected node within a network and process such information on its end to obtain a suitable graphical image of the information.

Thus, the embodiments described herein facilitate the generation of a dynamic and current network topology representation, e.g., in the form of a graphical image to be displayed by a computing device, where the current network topology can be obtained from any node within the network at any time (e.g., utilizing a CLI command, via HTTP access to a selected node, etc.). In addition, the graphical image of the current network topology can be enriched with information by overlaying additional graphical features representing current operating conditions of the network (e.g., operating conditions as previously described and depicted in FIGS. 4-8) to help a network operator or engineer visualize potential problems within the network (e.g., finding insufficient or “choke point” bandwidth locations within the network, identifying problems with particular nodes, etc.) so as to streamline solutions to maximizing the operational efficiency of the network.

The above description is intended by way of example only.

What is claimed is:

1. A method comprising:
establishing a connection between a computing device and a network comprising a plurality of nodes, each node connected with at least one other node within the network, each node further comprising a network element configured to receive and transmit data to and from other nodes;
sending a request for current network topology information from the computing device to any selected node within the network, wherein the selected node has current network topology information or has access to current network topology information that is located at another node;
receiving current network topology information at the computing device from the selected node; and
providing a graphical image of the current network topology at the computing device that is based upon the current network topology information.

2. The method of claim 1, wherein the request is sent by the computing device to the selected node via a CLI command, and wherein providing the graphical image of the current network topology to the computing device by the selected node comprises sending an email message.

3. The method of claim 1, wherein the selected node is configured to obtain network topology information for a network domain, and sending the request comprises sending the request for current network topology information limited to a portion of the network domain.

4. The method of claim 1, wherein providing the graphical image comprises providing additional information about at least one operational condition of the current network topology.

5. The method of claim 4, wherein the providing additional information comprises providing at least one of CPU usage of a computing device at one or more nodes of the network, an indication of bandwidth capacity between two or more nodes within the network, and an indication of a flow path of data between a source node and a destination node within the network.

6. The method of claim 1, wherein receiving the current network topology information at the computing device comprises receiving historical information about changes in the network topology over a selected time period, and providing the graphical image of the current network topology further comprises providing a plurality of graphical images depicting a topology of the network at different times over the selected time period.

7. The method of claim 1, further comprising obtaining the current network topology information by:
sending a request for current topology information from a source node within the network to a plurality of queried nodes of the network, the request being initiated at a first queried node that is directly connected with the source node, wherein the request facilitates a collection of topology information by further expanding the request in a direction away from the source node to other queried nodes disposed at increasingly outward expanding locations from the source node, each queried node requests topology information from neighboring nodes that are directly connected with the queried node, and the topology information comprises information about each queried node and each neighboring node that is directly connected with each queried node;
receiving the collected topology information at the source node from the first queried node and all other queried nodes, wherein each queried node directs its portion of the collected topology information through the network and back to the source node; and
generating the current network topology information at the source node based upon the collected topology information, wherein the current network topology information comprises a mapping of the connections between the source node, all queried nodes and all neighboring nodes directly connected with the source node and the queried nodes.

8. The method of claim 7, wherein the source node is the selected node to which the request for current network topology information is sent by the computing device.

9. The method of claim 7, wherein sending the request for current network topology information by the computing device comprises sending the request to the selected node which is other than the source node, such that the selected node obtains the current network topology information from the source node.

10. A system comprising:
a plurality of nodes, each node connected with at least one other node within a network, each node further comprising a network element configured to receive and transmit data to and from other nodes, wherein each node has current network topology information or has access to current network topology information that is located at another node; and
a computing device comprising a network interface configured to establish a connection with any node within the network, and a processor configured to:
select any node within the network to request and receive current network topology information from the selected node; and
provide a graphical image of the current network topology that is based upon the current network topology information.

11. The system of claim 10, wherein the processor is further configured to request current network topology information from the selected node via a CLI command, and the selected node is configured to provide the graphical image of the current network topology to the computing device via an email message.

12. The system of claim 10, wherein the selected node is configured to obtain network topology information for a network domain, and the processor is further configured to request current network topology information from the selected node that is limited to a portion of the network domain.

13. The system of claim 10, wherein the processor is further configured to provide the graphical image including additional information about at least one operational condition of the current network topology.

14. The system of claim 13, wherein the additional information comprises at least one of CPU usage of a computing device at one or more nodes of the network, an indication of bandwidth capacity between two or more nodes within the network, and an indication of a flow path of data between a source node and a destination node within the network.

15. The system of claim 10, wherein the current network topology information received at the computing device comprises historical information about changes in the network topology over a selected time period, and the processor is further configured to provide a plurality of graphical images depicting a topology of the network at different times over the selected time period.

16. The system of claim 10, further comprising a source node within the network, the source node comprising a processor configured to obtain the current network topology information by:
sending a request for current topology information from the source node to a plurality of queried nodes of the network, the request being initiated at a first queried node that is directly connected with the source node, wherein the request facilitates a collection of topology information by further expanding the request in a direction away from the source node to other queried nodes disposed at increasingly outward expanding locations from the source node, each queried node requests topology information from neighboring nodes that are directly connected with the queried node, and the topology information comprises information about each queried node and each neighboring node that is directly connected with each queried node;
receiving the collected topology information at the source node from the first queried node and all other queried nodes, wherein each queried node directs its portion of the collected topology information through the network and back to the source node; and
generating the current network topology information at the source node based upon the collected topology information, wherein the current network topology information comprises a mapping of the connections between the source node, all queried nodes and all neighboring nodes directly connected with the source node and the queried nodes.

17. One or more computer readable storage media encoded with software comprising computer executable instructions and when the software is executed operable to:
establish a connection between a computing device and a network comprising a plurality of nodes, each node connected with at least one other node within the network, each node further comprising a network element configured to receive and transmit data to and from other nodes;
send a request for current network topology information from the computing device to any selected node within the network, wherein the selected node has current network topology information or has access to current network topology information that is located at another node;
receive current network topology information at the computing device from the selected node; and
provide a graphical image of the current network topology at the computing device that is based upon the current network topology information.

18. The computer readable storage media of claim 17, wherein the instructions are further operable to send the request by the computing device to the selected node via a CLI command, and to provide the graphical image of the current network topology to the computing device by the selected node via an email message.

19. The computer readable storage media of claim 17, wherein the instructions are further operable to obtain network topology information for a network domain, and to limit the request for current network topology information by the computing device to a portion of the network domain.

20. The computer readable storage media of claim 17, wherein the instructions are further operable to provide the graphical image with additional information about at least one operational condition of the current network topology.

21. The computer readable storage media of claim 20, wherein the additional information comprises at least one of CPU usage of a computing device at one or more nodes of the network, an indication of bandwidth capacity between two or more nodes within the network, and an indication of a flow path of data between a source node and a destination node within the network.

22. The computer readable storage media of claim 17, wherein the instructions are further operable to provide current network topology information to the computing device comprising historical information about changes in the network topology over a selected time period, and to provide a plurality of graphical images depicting a topology of the network at different times over the selected time period.

23. The computer readable storage media of claim 17, and further comprising instructions that are operable to obtain the current network topology information by:
sending a request for current topology information from a source node within the network to a plurality of queried nodes of the network, the request being initiated at a first queried node that is directly connected with the source node, wherein the request facilitates a collection of topology information by further expanding the request in a direction away from the source node to other queried nodes disposed at increasingly outward expanding locations from the source node, each queried node requests topology information from neighboring nodes that are directly connected with the queried node, and the topology information comprises information about each queried node and each neighboring node that is directly connected with each queried node;
receiving the collected topology information at the source node from the first queried node and all other queried nodes, wherein each queried node directs its portion of the collected topology information through the network and back to the source node; and
generating the current network topology information at the source node based upon the collected topology information, wherein the current network topology information comprises a mapping of the connections between the source node, all queried nodes and all neighboring nodes directly connected with the source node and the queried nodes.
